(19) United States
(12) Patent Application Publication
(10) Pub. No.: US 2016/0049979 A1
(43) Pub. Date: Feb. 18, 2016

(54) Nogo - Protective cover with front camera cover for mobile devices

(71) Applicant: Erik Peter Grouwstra, Los Angeles, CA (US)

(72) Inventor: Erik Peter Grouwstra, Los Angeles, CA (US)

(21) Appl. No.: 14/461,784

(22) Filed: Aug. 18, 2014

(51) Int. Cl. H04B 1/3888

(52) U.S. Cl. CPC H04B 1/3888

(57) ABSTRACT

The present invention discloses a protective device for a mobile device (smart phone or tablet), comprising: a frame comprising a first sidewall, a second sidewall opposite to the first sidewall, a third sidewall and a fourth sidewall opposite to the third sidewall, the sidewalls being terminated with each other and attached to a backboard, thereby enclosing and defining a space for accommodating the mobile device; provided with an engaging feature allowing the front camera of the mobile device to be covered or uncovered, at the will of the owner. With the present invention, the front camera can be covered by snapping or sliding a small cover in place, or uncovered by lifting or sliding said little cover, thus ensuring protection from potential hackers using the front camera of the device for illegal purposes. The camera cover can be manufactured in any feasible shape and color (star-shaped, diamond-shaped, flower-shaped, heart-shaped, half circle-shaped, etc. etc.). The engaging feature and the mobile device protective cover are engaged with each other by means of an interference fit, a snap fit or a sliding connection

### BACKGROUND OF THE INVENTION

1. Field of the Invention

The present invention relates to a protective device for a mobile device, and more particularly, to a protective device with a movable front camera lens cover for a mobile device.

2. Description of the Prior Art

Protective casing, soft or hard, is generally formed integrally and configured to entirely cover and enclose the mobile device (phone/tablet) to provide protection while maintaining the user's personal style reflected by the housing. Nowadays, more and more consumers care about whether their personal items look fashionable and unique. With this invention, people will have more suitable control over their privacy by preventing a third party from using their device's camera function without permission from the device's owner, while maintaining the fashionable and unique look of the protective device.

Considering the massive breaches of security, frequently mentioned in the news around the world, a strong need has arisen for a mobile device protective cover with aforementioned feature, allowing the user of the device to be in full control of their privacy.

### SUMMARY OF THE INVENTION

In view of the situation described above, an object of the present invention is to provide a more comprehensive protective device for a mobile device so as to solve the problem associated with the current increase of the unknown, untraceable and uninvited use of the front camera of people's devices by a third party.

Preferably, the engaging feature and the protective device are in engagement with each other by an interference fit, a snap fit or a sliding connection.

The aforementioned aspects and other aspects of the present invention will be better understood when consideration is given to the following detailed description. Such description makes reference to the appended drawings.

### BRIEF DESCRIPTION OF THE DRAWINGS

FIG. 1 is a schematic representation illustrating the front side of a smart phone protective device in accordance with an embodiment of the present invention covering the lens of the front camera.

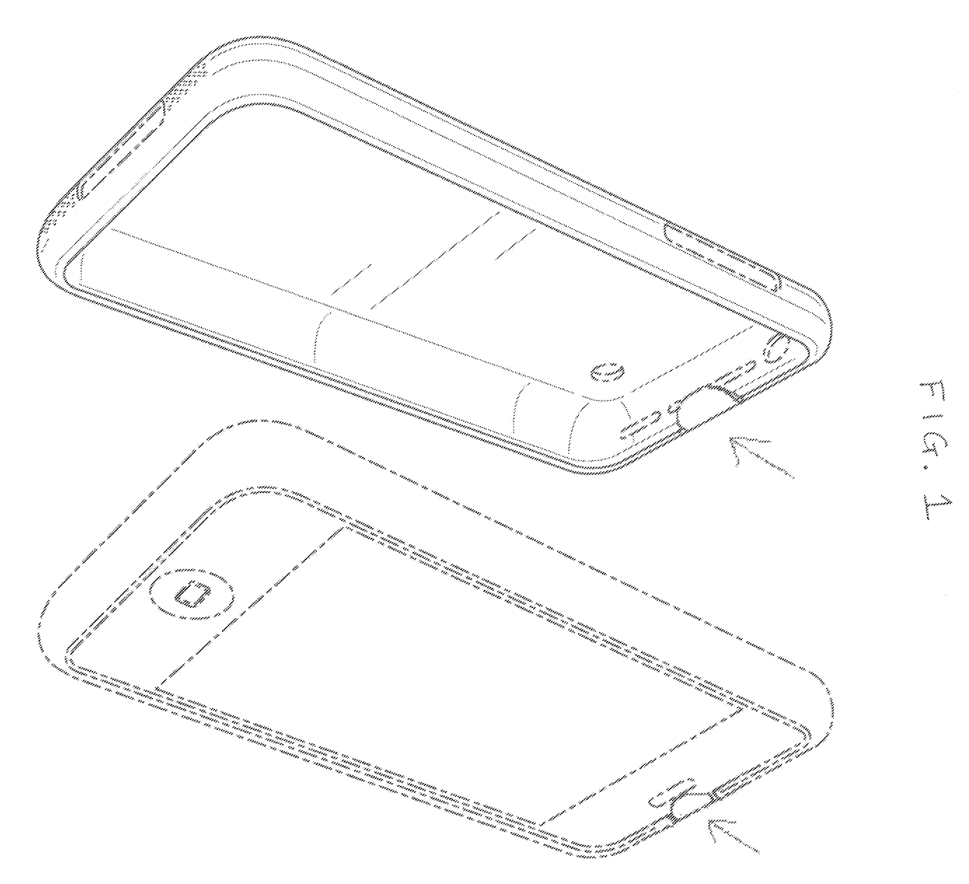

FIG. 2 is a schematic representation illustrating the back side of a smart phone protective device in accordance with an embodiment of the present invention not covering the lens of the front camera.

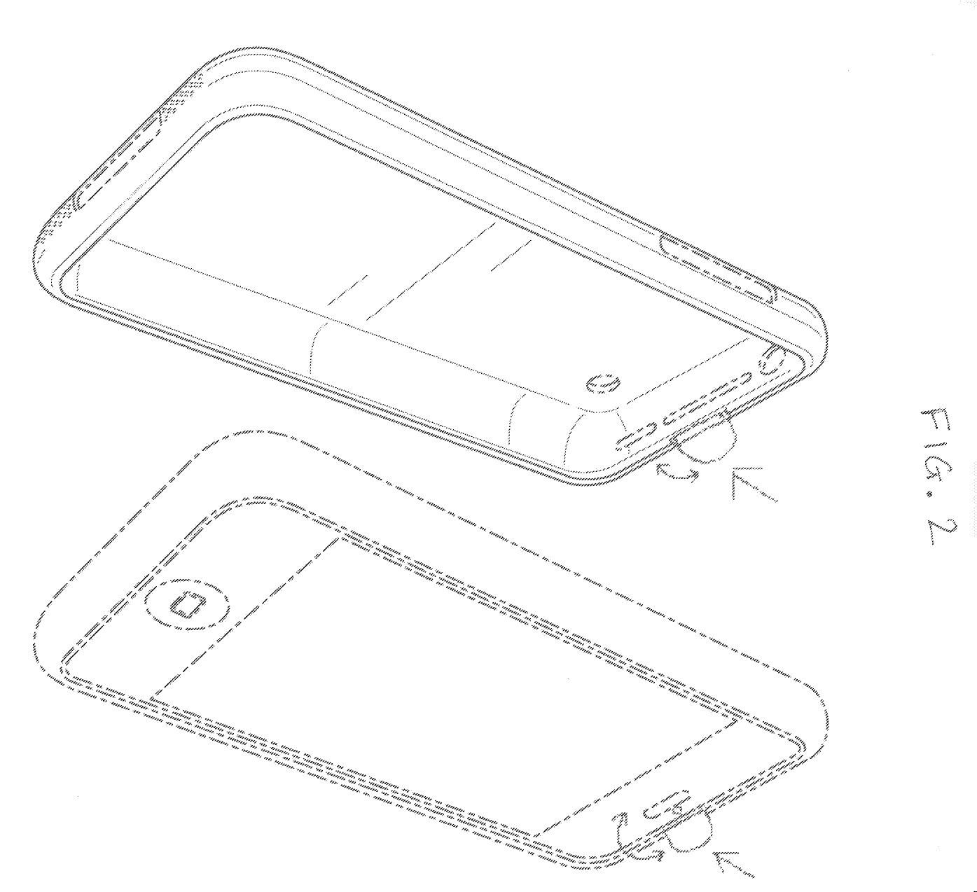

FIG. 3 is a schematic representation illustrating the front side of a tablet protective device in accordance with an embodiment of the present invention covering the lens of the front camera.

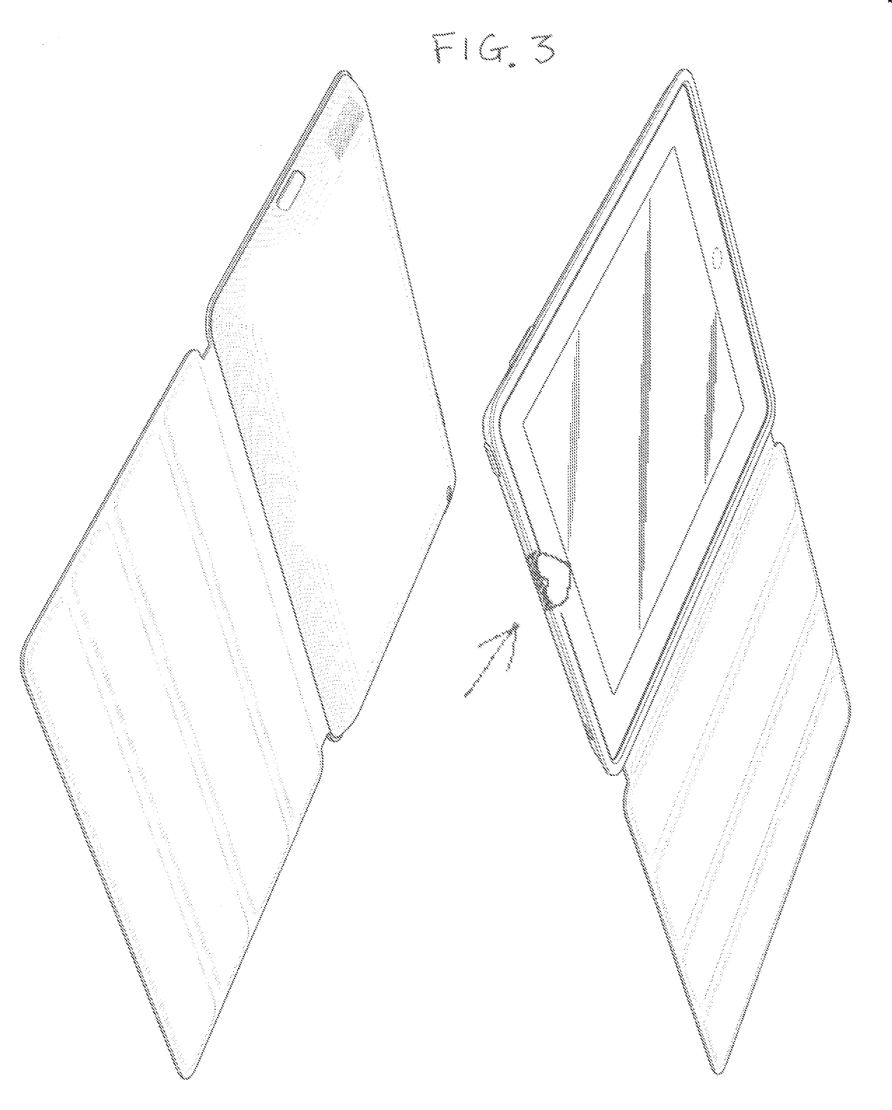

FIG. 4 is a schematic representation illustrating the back side of a tablet protective device in accordance with an embodiment of the present invention not covering the lens of the front camera.

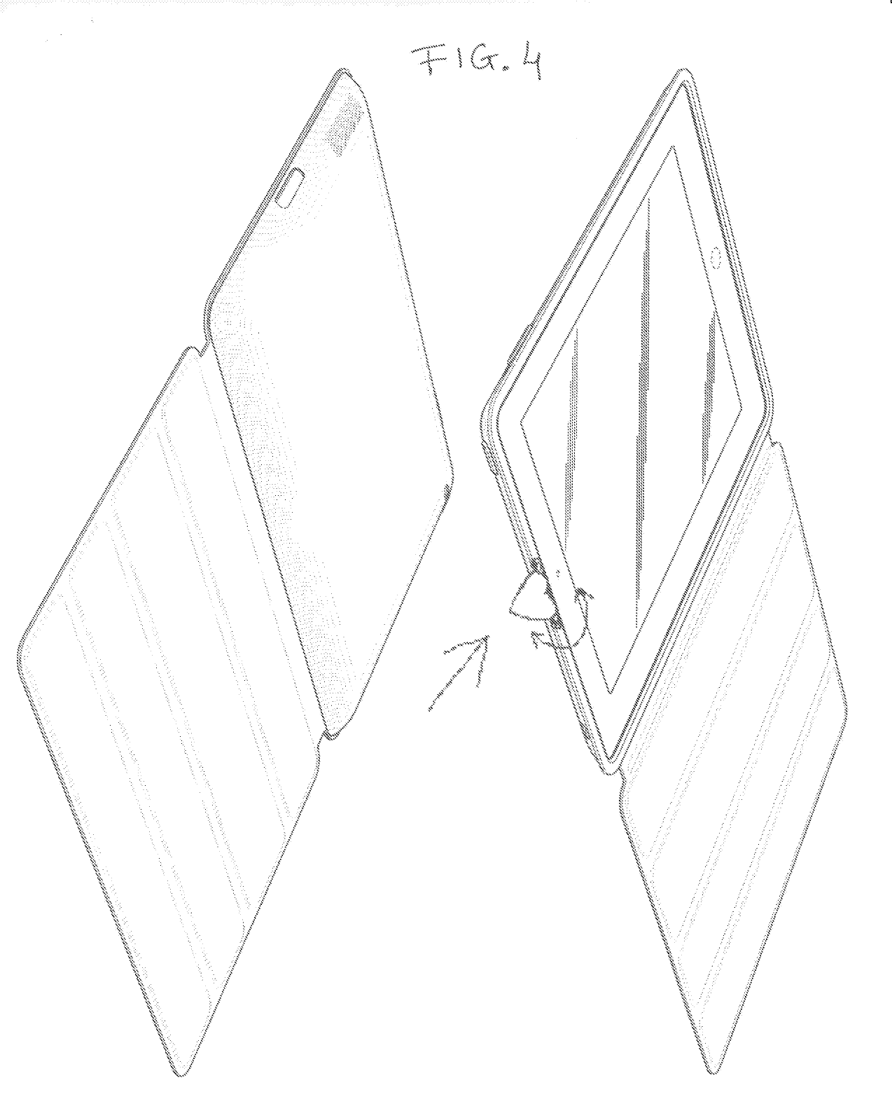

### DESCRIPTION OF THE PREFERRED EMBODIMENTS

The present invention will be fully described by way of preferred embodiments and appended drawings to facilitate the understanding of the technical features, contents and advantages of the present invention and the effect to be achieved by the present invention. It will be understood that the appended drawings are merely schematic representations and may not be illustrated. according to actual scale and precise arrangement of the implemented creation. Therefore, the scope of protection of the present invention shall not be construed based on the scale and arrangement illustrated on the appended drawings and limited thereto.

To sum up, the protective device for a mobile device of the present invention enables the user to cover or uncover the front camera lens of the mobile device and thus be in full charge of his or her privacy when it comes to illegal use of their front camera function by a third party.

The embodiments depicted above are exemplary and are not intended to limit the scope of the present invention. Any change or alteration with equivalent efficiency made without departing from the spirit and scope of this creation falls within the scope of the appended claims.

What is claimed is:

1. A protective device for a mobile device (smart phone or tablet), comprising: a frame comprising a first sidewall, a second sidewall opposite to the first sidewall, a third sidewall and a fourth sidewall opposite to the third sidewall, the sidewalls being terminated with each other and attached to a backboard, thereby enclosing and defining a space for accommodating the mobile device; provided with an engaging feature allowing the front camera lens of the mobile device to be covered or uncovered, at the will of the owner. With the present invention, the front camera lens can be covered by snapping or sliding a little cover in place, or uncovered by lifting or sliding said little cover, thus ensuring protection from potential hackers using the front camera of the device for illegal purposes.

2. The protective device according to claim 1, wherein the engaging feature is a small protruding cover, that perfectly covers the front camera of aforementioned mobile device.

3. The protective device according to claim 1, wherein the engaging feature and the mobile device protective cover are engaged with each other by means of an interference fit, a snap fit or a sliding connection.

4. The protective device according to claim 1, wherein the front camera cover is fitted with a thin, soft surface, protecting and cleaning the front camera lens of the mobile device when the front camera lens is covered.

5. The protective device according to claim 1, wherein the engaging feature can be manufactured in any material, shape or color, to match the attached mobile device protective cover and the mobile device owner's desire.
